(19) United States
(12) Patent Application Publication
(10) Pub. No.: US 2010/0163334 A1
(43) Pub. Date: Jul. 1, 2010

(54) SOUND MAXIMIZING AMMELLESCOPE

(76) Inventor: Hua David Jiang, Boston, MA (US)

Correspondence Address: David Jiang, APT 8, 45 Grove St, Boston, MA, 02114, US

(21) Appl. No.: 12/347,586

(22) Filed: Dec. 31, 2008

(51) Int. Cl. G10K 11/00

(52) U.S. Cl. 181/197

(57) ABSTRACT

In this device, three chambers, three chips with multiple holes and three membranes senses and magnifies sound signal from miles away to a magnitude that can be heard by device holder. Sound wave enter from the membrane, vibration energy is transmitted by highly compressed air within chamber 3, which then is magnified by multiple small holes in its chip. The same vibration is magnified by compressed air in chamber 2, which then is magnified by multiple small holes in its chip. Then the vibration is magnified by compressed air in chamber 1, which then is magnified by multiple small holes in its chip. Device holder adjust the air density in chamber 1, 2 and 2 by sliding chamber 3 inside chamber 2, and by sliding chamber 2 inside chamber 1. Sound wave is magnification in proportion to air compression ratio between two connected chambers, and magnified by holes on each of the three chips, thereby sound wave received from miles away is tremendously magnified.

### BACKGROUND OF THE INVENTION

1. Field of the Invention

This invention relates to a hand hold device that receives sound wave, which then be magnified to be heard by human ear. Device operator slides the chambers to change the air density in each chamber and the density ratio between two adjacent chambers.

2. Description of the Background Art

The invention of battery free sound magnifier devices has become a challenging journey. Apparatus such as telephone, microphone, and hearing aid devices could only process sound that can be heard by human ear. It limited the invention to electrical signal processing. It provided a challenge to inventors, however, i.e. weak sound which is generated from miles away and which populates to a human ear by air molecules can not be heard or processed by these devices.

For example, the humming sound produced by a hovering insect can be heard from 2 meters in a quiet environment by human ear. It can, however, be heard by some animals such as fox's ear from 20 meters. Biology study discovered that the air pressure between membrane and ear bone can be adjusted by the brain, muscles and nerves. Therefore, fox can adjust the inner ear air pressure to a better ratio than human. Fox and human, however, share the same basic ability to adjust their inner ear air compression ratio in order to hear the specific sound. This ability is actively used when they listen attentively to the weak sound and when they fall asleep. This ability is jeopardized by too low an air compression ratio when the subject is on an airplane which is taking off.

In the conventional devices, a microphone uses a single membrane and carbon particles to pick air molecules vibration. It limited the study to membrane material and carbon particles. It, however, never used connected chambers to compress air to a peak ratio to maximize sound output.

Further, the microphone picks noises, sound from near and far, and sound waves that are strong and weak simultaneously. It is therefore challenging to convert these vibrations to an electrical signal that is pure and simple. In reality, signals from microphone is always equivalent to what human ear can hear, waiting to be processed by electrical circuits and filters.

### SUMMARY OF THE INVENTION

Therefore, an object of this invention is to enable device operator to use a mechanical method to hear what a fox could hear without a battery or electrical signal processing.

Another object of this invention is to append such a device to a microphone so that weak sound can be magnified before it is sensed by the microphone.

In the first aspect, a human position this device next to his/her ear. Press chamber 1 tightly to his/her ear. He then slide chamber 2 against chamber 1, chamber 3 against chamber 2. Therefore, he or she maximize and minimize the sound wave entered by increasing and decreasing the density ratio between two adjacent chambers. Sound wave energy is multiplied and noises are filtered by each chip in the chamber.

In the second aspect, a human attach this device to the microphone device. He then slide chamber 2 against chamber 1, chamber 3 against chamber 2. Therefore, he or she could hear the corresponding sound from the speaker attached to the other end of microphone and choose the best sound quality that he/she wants to hear.

### BRIEF DESCRIPTION OF THE DRAWING

FIG. 1 is a cross-sectional view showing a structure of a Chamber 1.

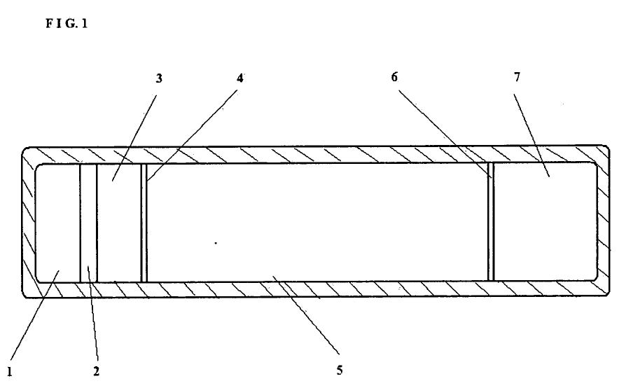

FIG. 2 is a cross-sectional view showing a structure of a Chamber 2.

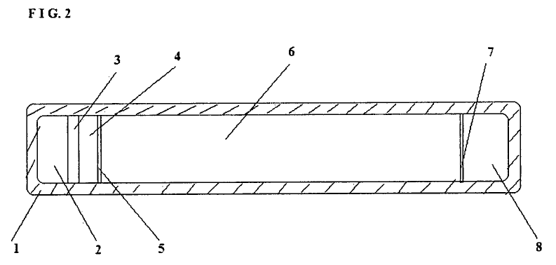

FIG. 3 is a cross-sectional view showing a structure of a Chamber 3.

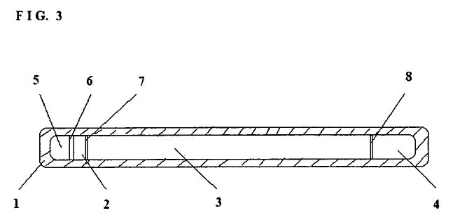

FIG. 4 is a cross-sectional view showing a structure of Chips in Chambers.

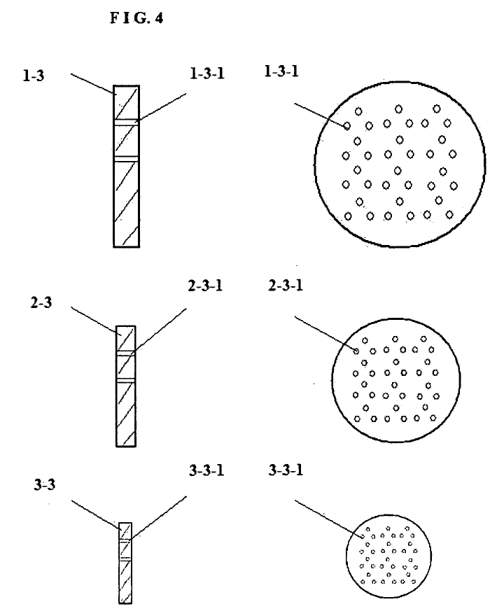

FIG. 5 is a cross-sectional view showing a installed whole body that has Chamber 1, Chamber 2, Chamber 3, Chip 1, Chip 2, Chip 3, Membranes in Chamber 1, 2 and 3.

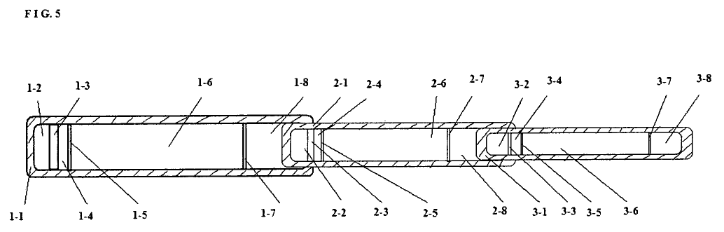

### DESCRIPTION OF THE PREFERRED EMBODIMENTS

Hereinafter, sound maximizing ammellescope device of the present invention will be described in detail with reference to the accompanying drawings. The device of the present invention is able to maximize weak sound wave to a level that can be heard by human ear when relative positions of each chamber are adjusted by device holder.

### First Embodiment

Device holder press Chamber 1 to his/her ear. Chamber 1 contains chip 1-3 which has multiple small holes to amplify the sound wave. It contains membrane 1-5 which works together with membrane 1-7 to compress the air inside Chamber 1 and between them.

### Second Embodiment

Device holder press Chamber 2 against Chamber 1. Chamber 2 contains chip 2-3 which has multiple small holes to amplify the sound wave. It contains membrane 2-5 which works together with membrane 2-7 to compress the air inside Chamber 2 and between them.

### Third Embodiment

Device holder press Chamber 3 against Chamber 2. Chamber 3 contains chip 3-3 which has multiple small holes to amplify the sound wave. It contains membrane 3-5 which works together with membrane 3-7 to compress the air inside Chamber 3 and between them.

Three chambers work together form air compression ratios between 1-6 and 2-6, and between 2-6 and 3-6. Air is prefilled in the space 1-6, 2-6, 3-6. These three air bodies contain air molecules that will react to pressure and to sound wave vibration. When the air molecules are under higher pressure, they are more active and then populate sound wave at a faster rate and higher quality.

Weak sound from long distance travels faster in 2-6 than in 3-6, even faster in 1-6 than in 2-6. Air molecules in 2-6 are more active than those in 3-6. Air molecules in 1-6 are more active than those in 2-6.

For example, the device operator slides Chamber 3, i.e., 3-1 body inward to Chamber 2, i.e., 2-1 body. The air pressure ratio between 2-6 and 3-6 will reach higher. Sound wave speed is doubled when this ratio is 2, tripled when this ratio is 3, so on and so forth. Eventually, the device operator hears that the sound heard reached a peak quality and can no longer be improved any more. Then he/she starts to slide Chamber 2, i.e., 2-1 body inward to Chamber 1, i.e., 1-1 body. The air pressure ratio between 1-6 and 2-6 will reach higher. Sound wave speed is doubled when this ratio is 2, tripled when this ratio is 3, so on and so forth. Eventually, the device operator hears that the sound heard reached a peak quality and can no longer be improved any more. The perfect magnification is reached. Weak sound wave is maximized by this present device. A human can hear the weak sound from a much further distance than simply using human ear.

Each of the three chips, i.e. 1-3, 2-3, 3-3 has multiple holes which will use the diffraction of multiple wave fronts. Each of the multiple wave fronts coincides at some point. When the device holder slides the chambers to a proper position, i.e. the strength of the wave is maximized at that point where wave fronts coincide, the energies of multiple fronts are combined.

The perfect position is when membrane 2-7 is at the diffraction point against Chip 3-3; membrane 1-7 is at the diffraction point against Chip 2-3, a human ear membrane is at the diffraction point against Chip 1-3.

What is claimed is:

1. A new method to magnify sound wave mechanically by filling three connected chambers with chips with multiple holes, compressed air, sound sensing membrane, and by sliding three connected chambers to adjust compress air pressure to a peak ratio.
